(19) United States
(12) Patent Application Publication
(10) Pub. No.: US 2014/0205452 A1
(43) Pub. Date: Jul. 24, 2014

(54) WIND TURBINE BLADE

(71) Applicant: United Technologies Corporation, Hartford, CT (US)

(72) Inventor: Robert H. Perkinson, Stonington, CT (US)

(73) Assignee: United Technologies Corporation, Hartford, CT (US)

(21) Appl. No.: 14/162,835

(22) Filed: Jan. 24, 2014

Related U.S. Application Data
(60) Provisional application No. 61/756,405, filed on Jan. 24, 2013.

(51) Int. Cl. F03D 7/02; F03D 1/06

(52) U.S. Cl. CPC F03D 7/0224; F03D 1/0633
USPC 416/1; 416/223 R; 416/147

(57) ABSTRACT

A rotor blade including a blade root, an aft-swept portion, and straight portion. The blade root defines a pitch axis for the rotor blade. The aft-swept portion is at an end of the rotor blade opposite the blade root. The straight portion is between the blade root and the aft-swept portion. The straight portion includes a straight portion elastic axis and a straight portion center of pressure. The straight portion elastic axis is parallel to the pitch axis. The straight portion center of pressure is spaced apart from the pitch axis in a forward direction.

### BACKGROUND

The present invention relates blades for a wind turbine. In particular, the invention relates to a swept blade for a wind turbine.

A wind turbine for power generation typically includes a set of large rotor blades, each blade mounted to a hub at a blade root. The rotor blades aerodynamically interact with the wind and create lift, which is translated into a driving torque at the hub. The rotating hub drives a generator either directly or through a gearbox. Aerodynamic interaction between the rotor blades and the wind is controlled by a pitch control actuator in the hub connected to the blade root of each rotor blade.

Wind gusts striking a rotor blade can cause extreme bending loads at the blade root. Some blades include an aft, in-plane sweep in an outer portion of the blade near the blade tip to counteract the effect of wind gusts. A wind gust striking such a blade forces the aft-swept portion aft and, due to the sweep, causes a portion of the blade between the blade tip and the blade root to twist into the wind gust. This increase in blade pitch reduces the bending load at the blade root, counteracting the effect of the wind gust. This effect is commonly referred to as bend-twist coupling.

When bend-twist coupling occurs, the twisting moment of the blade produces a corresponding torque at the blade root which must be endured by the blade pitch control system. This twist-induced torque may be enough to overwhelm the pitch control actuator. Alternatively, the pitch control actuator may be made larger with increased output to handle the twist-induced torque, but at a significant increase in cost. Thus, there is a need for a rotor blade designed for bend-twist coupling that also reduces twist-induced torque experienced at the pitch control actuator during wind gusts.

### SUMMARY

An embodiment of the present invention is a rotor blade including a blade root, an aft-swept portion, and straight portion. The blade root defines a pitch axis for the rotor blade. The aft-swept portion is at an end of the rotor blade opposite the blade root. The straight portion is between the blade root and the aft-swept portion. The straight portion includes a straight portion elastic axis and a straight portion center of pressure. The straight portion elastic axis is parallel to the pitch axis. The straight portion center of pressure is spaced apart from the pitch axis in a forward direction.

### BRIEF DESCRIPTION OF THE DRAWINGS

FIG. 1 is a front view of a portion a wind turbine illustrating a rotor blade embodying the present invention.

FIG. 2 is a side view of a portion the wind turbine of FIG. 1 showing an end view of the rotor blade embodying the present invention during a wind gust.

### DETAILED DESCRIPTION

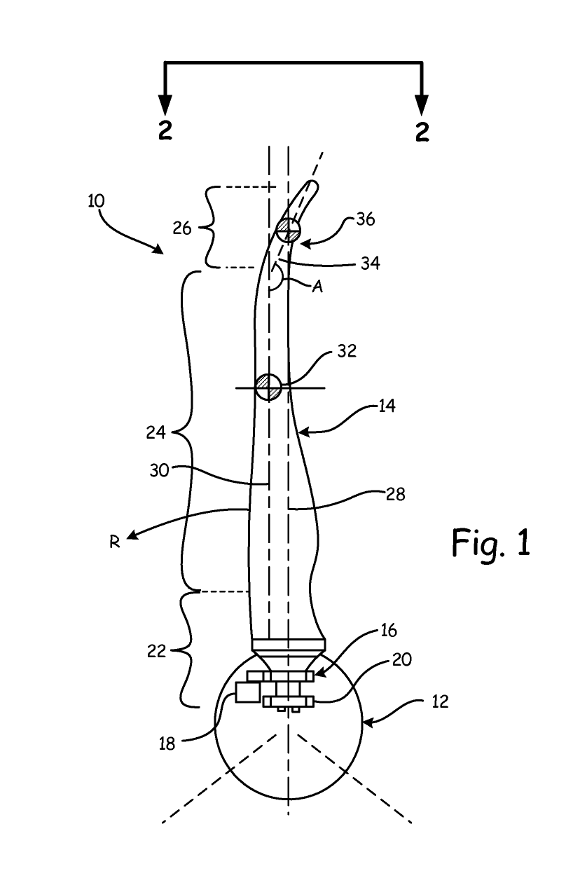

This application claims the benefit of U.S. Provisional Application No. 61/756,405 filed Jan. 24, 2013, and incorporated herein by reference. FIG. 1 is a front view of a portion a wind turbine illustrating a rotor blade embodying the present invention. FIG. 1 shows wind turbine 10 including hub 12 and rotor blade 14. Hub 12 is shown in phantom to better illustrate rotor blade 14. In this embodiment, rotor blade 14 is one of three identical rotor blades 14. For brevity, only one rotor blade 14 is illustrated. Hub 12 includes pitch actuation hardware 16. Pitch actuation hardware 16 includes pitch actuator 18 and pitch bearing 20. Rotor blade 14 includes blade root 22, straight portion 24, and aft-swept portion 26. Blade root 22 defines pitch axis 28. Straight portion 24 includes straight portion elastic axis 30 and straight portion center of pressure 32. Aft-swept portion 26 includes swept portion elastic axis 34 and swept portion center of pressure 36. Pitch actuator 18 is a device for causing rotor blade 14 to rotate about pitch axis 28, such as an electric motor and gear train. Straight portion elastic axis 30 is an axis around which straight portion 24 rotates under applied torque. Straight portion center of pressure 32 is a point representing pressure integrated over the entire surface of straight portion 24 of rotor blade 14. Similarly, swept portion elastic axis 34 is an axis around which aft-swept portion 24 rotates under applied torque. Swept portion center of pressure 36 is a point representing pressure integrated over the entire surface of aft-swept portion 26 of rotor blade 14.

Pitch bearing 20 rotatably connects blade root 22 of rotor blade 14 to hub 12. Pitch actuator 18 also connects to blade root 22 and hub 12 to control rotation of rotor blade 14 about pitch axis 28. Straight portion 24 projects from blade root 22. In this embodiment, aft-swept portion 26 is adjacent to straight portion 24 opposite blade root 22 such that together, blade root 22, straight portion 24, and aft-swept portion 26 form rotor blade 14 as a continuous structure. Straight portion elastic axis 30 is parallel to pitch axis 28. Swept portion elastic axis 34 forms angle A with pitch axis 28, thus creating a sweep. Angle A is such that swept portion elastic axis 34 projects in an aft direction, thus creating the aft sweep of aft-swept portion 26. Straight portion center of pressure 32 is spaced from pitch axis 28 in a forward direction. Swept portion center of pressure 36 is spaced from straight portion center of pressure 32 in the aft direction.

In operation, rotor blade 14 aerodynamically interacts with wind and creates lift, which is translated into a driving torque at hub 12. Hub 12 rotates in direction R and drives a generator either directly or through a gearbox (not shown). Aerodynamic interaction between rotor blade 14 and the wind is controlled by pitch actuator 18, which changes the pitch of rotor blade 14 to increase or decrease lift.

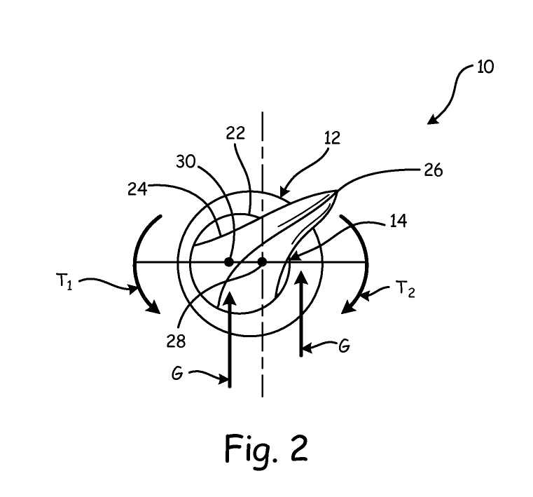

FIG. 2 is a side view of a portion wind turbine 10 of FIG. 1 showing an end view of rotor blade 14 during wind gust G. As shown in FIG. 2, as wind gust G strikes rotor blade 14, wind gust G bends aft-swept portion 26 in the aft direction and, due to the sweep, this twists straight portion 24 about straight portion elastic axis 30 and into wind gust G. This increase in blade pitch reduces the bending load at blade root 22, counteracting the effect of the wind gust as described above. The twisting of straight portion 24 produces a corresponding torque T1. However, wind gust G also increases the pressure at straight portion center of pressure 32. Because straight portion center of pressure 32 is spaced forward, or offset, from pitch axis 28, this pressure increase produces a corresponding torque T2 acting in a direction opposite to torque T1. Torque T2 in opposition to torque T1 at least reduces the net torque which must be endured by pitch actuator 18. By strategically selecting the offset of straight portion center of pressure 32, and angle A which determines the aft-sweep for aft-swept portion 26, some, or all of the resultant torque experienced by pitch actuator 18 is eliminated.

While the above description is in terms of the benefits under conditions of wind gust G, it is important to note that rotor blade 14 also reduces the net torque pitch actuator 18 experiences under steady-state operating conditions. It is notable that because both straight portion center of pressure 32 and straight portion elastic axis 30 are forward of pitch axis 28, they will necessarily be proximate to each other due to the limited space between pitch axis 28 and the most forward edge of rotor blade 14.

Rotor blades embodying the present invention not only reduce bending loads, but reduce the related torque experienced by pitch actuation hardware. This permits the use of lighter, less expensive pitch actuation hardware, and reduces the parasitic power requirements associated with pitch control. Rotor blades embodying the present invention are also typically less expensive to manufacture because the blade is straight, except for the aft-swept portion.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### DISCUSSION OF POSSIBLE EMBODIMENTS

The following are non-exclusive descriptions of possible embodiments of the present invention.

A rotor blade includes a blade root, an aft-swept portion, and a straight portion. The blade root defines a pitch axis for the rotor blade. The aft-swept portion is at an end of the rotor blade opposite the blade root. The straight portion is between the blade root and the aft-swept portion. The straight portion includes a straight portion elastic axis and a straight portion center of pressure. The straight portion elastic axis is parallel to the pitch axis. The straight portion center of pressure is spaced from the pitch axis in a forward direction.

The rotor blade of the preceding paragraph can optionally include, additionally and/or alternatively, any one or more of the following features, configurations, and/or additional components:
the aft-swept portion includes a swept portion elastic axis forming an angle with the pitch axis in an aft direction, and a swept portion center of pressure spaced from the straight portion center of pressure in the aft direction; and
the straight portion elastic axis is spaced from the pitch axis in the forward direction;

A wind turbine including a hub and a plurality of rotor blades attached to the hub. Each of the rotor blades includes a blade root, an aft-swept portion, and a straight portion. The blade root is connected to the hub and defines a pitch axis for the rotor blade. The aft-swept portion is at an end of the rotor blade opposite the blade root. The straight portion is between the blade root and the aft-swept portion. The straight portion includes a straight portion elastic axis and a straight portion center of pressure. The straight portion elastic axis is parallel to the pitch axis. The straight portion center of pressure is spaced from the pitch axis in a forward direction.

The wind turbine of the preceding paragraph can optionally include, additionally and/or alternatively, any one or more of the following features, configurations, and/or additional components:
the hub includes a plurality of pitch bearings, each pitch bearing rotatably connecting the blade root of one of the plurality of rotor blades to the hub, and a plurality of pitch actuators, each pitch actuator controlling the rotation of one of the plurality of rotor blades about the pitch axis of the rotor blade;
the aft-swept portion of each of the plurality of rotor blades includes a swept portion elastic axis forming an angle with the pitch axis in an aft direction, and a swept portion center of pressure spaced from the straight portion center of pressure in the aft direction; and
the straight portion elastic axis of each of the plurality of rotor blades is spaced from the pitch axis in the forward direction.

A method for reducing net torque applied to pitch actuation hardware by a bend-twist coupled wind turbine rotor blade struck by a wind gust includes bending an aft-swept portion of the rotor blade in response to a wind gust. The method includes twisting the rotor blade in response to the bending of the aft-swept portion of the rotor blade to produce a first torque in a first direction about a pitch axis of the rotor blade. The method also includes increasing pressure on a straight portion of the rotor blade in response to the wind gust striking the rotor blade, the increasing pressure centered forward of the pitch axis to produce a second torque in a second direction about the pitch axis of the rotor blade, the second direction opposing the first direction to reduce the net torque about the pitch axis.

1. A rotor blade comprising:
a blade root defining a pitch axis for the rotor blade;
an aft-swept portion at an end of the rotor blade opposite the blade root; and
a straight portion between the blade root and the aft-swept portion, the straight portion including:
a straight portion elastic axis parallel to the pitch axis; and
a straight portion center of pressure spaced from the pitch axis in a forward direction.

2. The rotor blade of claim 1, wherein the aft-swept portion includes:
a swept portion elastic axis forming an angle with the pitch axis in an aft direction; and
a swept portion center of pressure spaced from the straight portion center of pressure in the aft direction.

3. The rotor blade of claim 1, wherein the straight portion elastic axis is spaced from the pitch axis in the forward direction.

4. A wind turbine comprising:
a hub; and
a plurality of rotor blades attached to the hub, each rotor blade including:
a blade root connected to the hub, the blade root defining a pitch axis for the rotor blade;
an aft-swept portion at an end of the rotor blade opposite the blade root; and
a straight portion between the blade root and the aft-swept portion, the straight portion including:
a straight portion elastic axis parallel to the pitch axis; and
a straight portion center of pressure spaced from the pitch axis in a forward direction.

5. The wind turbine of claim 4, wherein the hub includes:
a plurality of pitch bearings, each pitch bearing rotatably connecting the blade root of one of the plurality of rotor blades to the hub; and
a plurality of pitch actuators, each pitch actuator controlling the rotation of one of the plurality of rotor blades about the pitch axis of the rotor blade.

6. The wind turbine of claim 5, wherein the aft-swept portion of each of the plurality of rotor blades includes:
a swept portion elastic axis forming an angle with the pitch axis in an aft direction; and
a swept portion center of pressure spaced from the straight portion center of pressure in the aft direction.

7. The wind turbine of claim 5, wherein the straight portion elastic axis of each of the plurality of rotor blades is spaced from the pitch axis in the forward direction.

8. A method for reducing net torque applied to pitch actuation hardware by a bend-twist coupled wind turbine rotor blade struck by a wind gust, the method comprising:
bending an aft-swept portion of the rotor blade in response to a wind gust;
twisting the rotor blade in response to the bending of the aft-swept portion of the rotor blade to produce a first torque in a first direction about a pitch axis of the rotor blade; and
increasing pressure on a straight portion of the rotor blade in response to the wind gust striking the rotor blade, the increasing pressure centered forward of the pitch axis to produce a second torque in a second direction about the pitch axis of the rotor blade, the second direction opposing the first direction to reduce the net torque about the pitch axis.
